(19) United States
(12) Patent Application Publication
(10) Pub. No.: US 2023/0010208 A1
(43) Pub. Date: Jan. 12, 2023

(54) BAGGING DEVICE

(71) Applicant: TOSHIBA TEC KABUSHIKI KAISHA, Tokyo (JP)

(72) Inventor: Atsushi Otake, Mishima Shizuoka (JP)

(21) Appl. No.: 17/715,071

(22) Filed: Apr. 7, 2022

(30) Foreign Application Priority Data
Jul. 7, 2021 (JP) 2021-112862

(51) Int. Cl. B65B 5/06; G07G 1/00; B65B 35/12

(52) U.S. Cl. CPC B65B 5/067; G07G 1/0018; B65B 35/12

(57) ABSTRACT

According to one embodiment, a bagging device includes a commodity placing unit having an inclined surface and on which a commodity is placed, an openable and closable door provided at the lowermost portion of the inclined surface, determining the position of the commodity placed on the commodity placing unit in a closed state, and allowing the placed commodity to slide outward along the inclined surface in an open state, and a storage mechanism for dropping the slid commodity into a storage body set at a sliding movement destination of the commodity.

### CROSS-REFERENCE TO RELATED APPLICATION

This application is based upon and claims the benefit of priority from Japanese Patent Application No. 2021-112862, filed on Jul. 7, 2021, the entire contents of which are incorporated herein by reference.

### FIELD

Embodiments described herein relate generally to a bagging device, a bagging method, and a self service point-of-sale system.

### BACKGROUND

Recently, mass retailers, convenience stores, clothing stores, and the like widely use self-service POS terminals that perform a commodity registration process by automatically reading the wireless tags attached to commodities and a settlement process if a customer places a basket containing the commodities to be purchased at the checkout position.

Such a self-service POS terminal requires a bagging operation in which the customer himself or herself puts the settled commodities into a bag such as his or her own bag from the basket, which is troublesome.

### DESCRIPTION OF THE DRAWINGS

FIG. 1 is a perspective view of a self-service POS terminal according to an embodiment;

FIG. 2 is a perspective view showing a configuration of a basket;

FIG. 3 is a perspective view showing the configuration of the basket;

FIG. 4 is an explanatory diagram showing the inside of the self-service POS terminal;

FIG. 5 is an explanatory diagram showing the inside of the self-service POS terminal;

FIG. 6 is a block diagram showing a hardware configuration of the self-service POS terminal;

FIG. 7 is a functional block diagram showing a functional configuration of the self-service POS terminal;

FIG. 8 is a flowchart showing a control process of the self-service POS terminal;

FIG. 9 is an explanatory diagram showing the inside of a self-service POS terminal (modification); and

FIG. 10 is an explanatory diagram showing the inside of the self-service POS terminal (modification).

### DETAILED DESCRIPTION

An aspect achieved by the present disclosure is to provide a bagging device capable of reducing the efforts of bagging.

In general, according to one embodiment, the bagging device includes a commodity placing unit having an inclined surface and on which a commodity is placed, an openable and closable door provided at the lowermost portion of the inclined surface, determining the position of the commodity placed on the commodity placing unit in a closed state, and allowing the placed commodity to move outward along the inclined surface in an open state, and a storage mechanism for dropping the moved commodity into a storage body set at the movement destination of the commodity.

Hereinafter, embodiments will be described with reference to the drawings. In the embodiment, a self-service POS terminal installed in a store such as a supermarket, a home center, a clothing store, or a convenience store (in the embodiment, the clothing store will be described as an example) will be described as an example of a bagging device. The present disclosure is not limited to the embodiments described below.

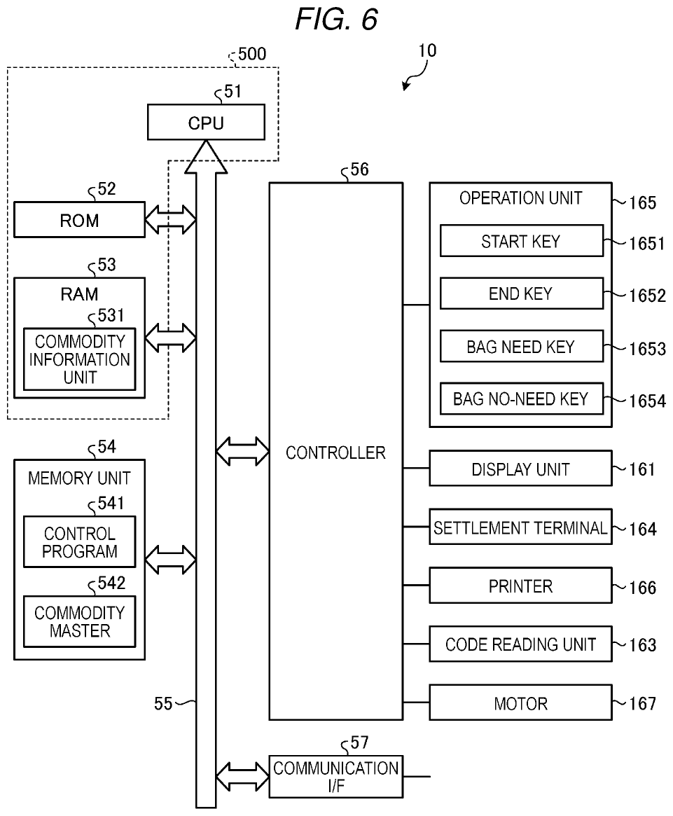

A clothing store is a store that sells clothing. A customer receives a basket (an example of a storage unit) for storing commodities at the entrance of the store. The customer puts the commodity such as clothes to be purchased in the basket (stores the commodity in the basket) in the store. All commodities in the store are attached with wireless tags (for example, RFID (Radio Frequency Identification) tags). The self-service POS terminal is operated by the customer himself or herself. If the customer places the commodity-stored basket on the commodity placing unit and operates a start key 1651 (see FIG. 6), the self-service POS terminal receives a radio wave including the information of the commodity that was transmitted from the wireless tag attached to the commodity stored in the basket, and acquires the commodity code (commodity identification information for identifying the commodity).

The self-service POS terminal is a device that performs the commodity registration process related to the commodity based on the acquired commodity code and settlement process related to the transaction. In addition, the self-service POS terminal processes the bagging of the settled commodities.

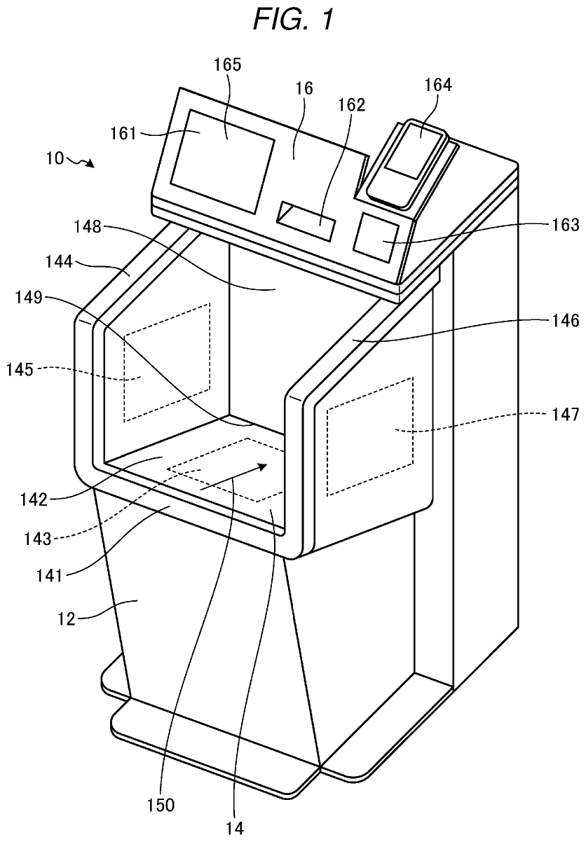

The commodity registration process includes a process of retrieving the commodity information such as the commodity name and price of the commodity from the commodity master 542 (see FIG. 6) and displaying the commodity information on the display unit 161 (see FIGS. 1 and 6) based on the acquired commodity code, and storing the commodity information in a commodity information unit 531 (see FIG. 6). The settlement process refers to a process of displaying the total amount of money and change amount related to transactions with the customer (hereinafter referred to as “settlement information”) based on the commodity information of the commodity subjected to the commodity registration process and making a settlement using, for example, a credit card or an application software installed on a mobile terminal. The settlement process includes a process of dispensing a receipt printed with commodity information and settlement information of the settled commodity.

FIG. 1 is a perspective view of the self-service POS terminal according to the embodiment. As shown in FIG. 1, the self-service POS terminal 10 includes a main body unit 12, a commodity placing unit 14, and an operation unit 16. The main body unit 12 houses the power supply and equipment of the self-service POS terminal 10. Further, the main body unit 12 stores a storage mechanism 30 described later.

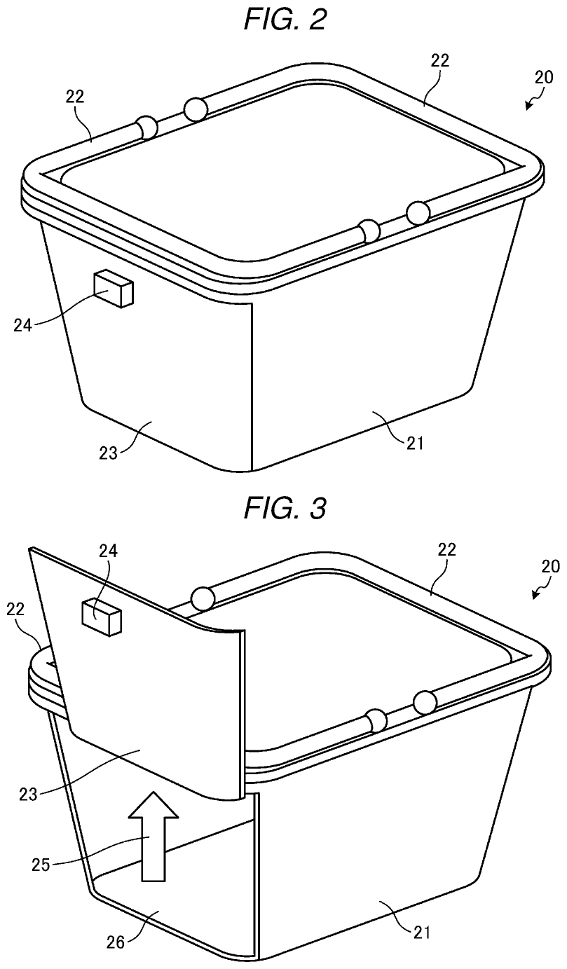

The commodity placing unit 14 is a table on which a basket 20 (see FIGS. 2 and 3) is placed. The commodity placing unit 14 includes a bottom surface portion 141, a left side surface portion 144, a right side surface portion 146, and a door 148. The bottom surface portion 141 is a substantially flat surface constituting the bottom surface of the commodity placing unit 14. The bottom surface portion 141 has an inclined surface 142. The inclined surface 142 is an inclined surface (flat surface) that gradually descends from the front side (front side) to the back side (rear side) of the self-service POS terminal 10. That is, the inclined surface 142 is an inclined surface that gradually descends in the direction of the arrow 150. The position on the innermost side (lowest position) of the inclined surface 142 is a lowermost portion 149. The lowermost portion 149 is the lowest position on the inclined surface 142. An antenna 143 is embedded in the inclined surface 142. The antenna 143 receives a radio wave including information for identifying a commodity (individual commodity) transmitted by a wireless tag attached to the commodity placed on the commodity placing unit 14.

The left side surface portion 144 is a surface constituting the left side surface of the commodity placing unit 14. The left side surface portion 144 is erected at a substantially right angle from the left end portion of the bottom surface portion 141. An antenna 145 is embedded in the left side surface portion 144. The antenna 145 receives a radio wave including information for identifying a commodity (individual commodity) transmitted by a wireless tag attached to the commodity placed on the commodity placing unit 14.

The right side surface portion 146 is a surface constituting the right side surface of the commodity placing unit 14. The right side surface portion 146 is erected at a substantially right angle from the right end portion of the bottom surface portion 141. An antenna 147 is embedded in the right side surface portion 146. The antenna 147 receives a radio wave including information for identifying a commodity (individual commodity) transmitted by a wireless tag attached to the commodity placed on the commodity placing unit 14.

The door 148 is provided at the lowermost portion 149 of the commodity placing unit 14. The door 148 can be moved up and down by the rotation of a motor 167 (see FIG. 6). If the door 148 is located in the lower position, the door 148 is in the closed state. The closed state means a state in which the door 148 is closed and the commodity placed on the commodity placing unit 14 stays on the inclined surface 142. If the door 148 is in the closed state, the basket 20 placed on the commodity placing unit 14 comes into contact with the door 148 at the lowermost portion 149. If the basket 20 comes into contact with the door 148 at the lowermost portion 149, the basket 20 and the commodities stored in the basket 20 are positioned at the commodity placing unit 14.

Further, if the door 148 is located at the upper position, the door 148 is in the open state. The open state is a state in which the door 148 is raised upward and the commodity stored in the basket 20 can slide (slide down) along the inclined surface 142. If the door 148 is in the open state, the details will be described later, but an opening and closing portion 23 of the basket 20 is opened so that the commodities stored in the basket 20 can slide along the inclined surface 142.

The operation unit 16 includes a display unit 161, an operation unit 165, a printer 166, a code reading unit 163, and a settlement terminal 164. The display unit 161 displays information to the customer. The display unit 161 displays, for example, the commodity information of the commodity purchased by the customer (the commodity stored in the basket 20 placed on the commodity placing unit 14) based on the information received by the antenna 143, the antenna 145, and the antenna 147. In addition, the display unit 161 displays images of various keys described later. The operation unit 165 is, for example, a touch panel provided on the display unit 161. By operating the touch panel at the position corresponding to the key displayed on the display unit 161, the operation unit 165 plays the role of the key.

The printer 166 dispenses a receipt printed with commodity information and settlement information related to the settled commodity thereon. The code reading unit 163 is a camera or an optical scanner that reads a code (for example, a two-dimensional code) displayed on a mobile terminal when making an application software settlement using the mobile terminal (not shown). The settlement terminal 164 is a terminal operated when making a settlement using, for example, a credit card or an electronic money card.

The customer places the basket 20 containing the commodity to be purchased on the commodity placing unit 14. The basket 20 is placed on the inclined surface 142 of the commodity placing unit 14. Therefore, the basket 20 placed on the commodity placing unit 14 is placed to be inclined to the back side by the tilt angle of the inclined surface 142. The basket 20 slides on the inclined surface 142 and comes into contact with the closed door 148 at the lowermost portion 149. The basket 20 is positioned at a position in contact with the door 148. This position is the optimum position for the antenna 143, the antenna 145, and the antenna 147 to receive radio waves from the wireless tag attached to the commodity stored in the basket 20.

Next, the customer operates the operation unit 165. In response to the operation of the customer, the self-service POS terminal 10 receives the information of the wireless tag attached to the commodity stored in the basket 20. Then, the self-service POS terminal 10 acquires the commodity code based on the information of the received wireless tag information and executes the commodity registration process related to the commodity. The customer then selects a medium to pay. The self-service POS terminal 10 executes the settlement process using the selected medium.

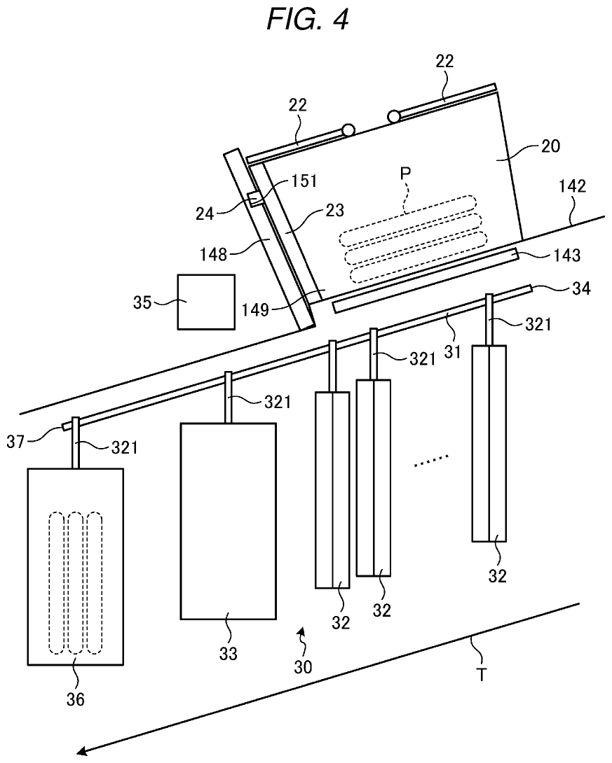

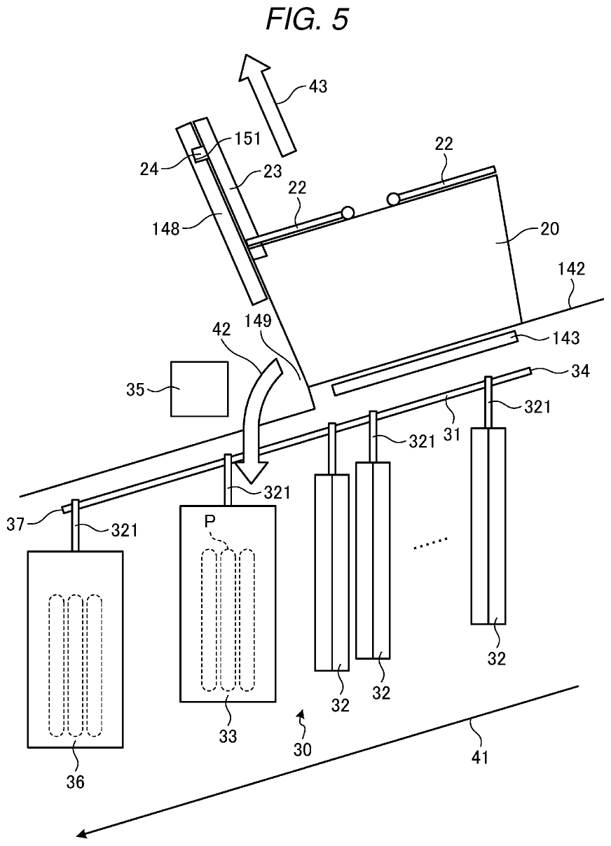

The customer then selects the need for a bag to put the purchased commodity. Upon selecting a need for the bag, the self-service POS terminal 10 moves the door 148 in the closed state upward to make the door 148 in the open state. As the door 148 moves upward, the opening and closing portion 23 of the basket 20 moves upward and is opened. Then, the commodity stored in the basket 20 slides along the inclined surface 142, drops into the set bag 33 and is stored in the bag 33. The setting of the bag 33 will be described later with reference to FIGS. 4 and 5.

Next, the configuration of the basket 20 will be described. FIGS. 2 and 3 are perspective views showing the configuration of the basket 20. The basket 20 is made of, for example, a resin material. The basket 20 has a storage unit 21 and a handle 22. The storage unit 21 is a recessed box body having an open upper portion capable of storing commodities inside. The handle 22 is rotatably attached to the upper portion of the storage unit 21. The customer uses the basket 20 by supporting the handle 22.

Further, the basket 20 is provided with the opening and closing portion 23 on one side surface of the storage unit 21. The opening and closing portion 23 can move up and down. FIG. 2 shows a closed state in which the opening and closing portion 23 moved downward. FIG. 3 shows an open state in which the opening and closing portion 23 moved upward (in the direction of the arrow 25). If the opening and closing portion 23 is in the open state, an opening 26 is formed on one side surface of the storage unit 21 of the basket 20. The commodities stored in the basket 20 can be moved to the outside through the opening 26.

The opening and closing portion 23 forms one side surface of the storage unit 21 in the closed state. Therefore, if the opening and closing portion 23 is closed, the commodities stored in the basket 20 do not move to the outside. The opening and closing portion 23 maintains a closed state by its own weight. Alternatively, the opening and closing portion 23 is biased downward (in the direction opposite to the arrow 25) by a biasing member to maintain the closed state.

The opening and closing portion 23 is provided with a protrusion 24 on the outer surface. If the basket 20 is placed on the commodity placing unit 14 and abuts on the door 148 (that is, if the basket 20 is positioned at the lowermost portion 149), the protrusion 24 is engaged with a recess 151 (see FIGS. 4 and 5) provided in the door 148 (the protrusion 24 fits into the recess 151). Then, if the door 148 moves upward and is opened, the opening and closing portion 23 moves upward together with the door 148 and is opened to form the opening 26. A rail (not shown) is formed in the basket 20, and the opening and closing portion 23 moves up and down by moving along the rail.

Next, the bag mechanism provided inside the self-service POS terminal 10 and the sliding movement of the commodity into the bag will be described. FIGS. 4 and 5 are explanatory diagrams showing the inside of the self-service POS terminal 10. FIG. 4 is an explanatory diagram showing the inside of the self-service POS terminal 10 in the closed state of the door 148. FIG. 5 is an explanatory diagram showing the inside of the self-service POS terminal 10 in the open state of the door 148.

As shown in FIG. 4, the self-service POS terminal 10 includes the storage mechanism 30. The storage mechanism 30 is provided inside the self-service POS terminal 10 under the commodity placing unit 14 and the door 148. The storage mechanism 30 includes a guide portion 31 and a bag opening mechanism 35. The guide portion 31 is a member for setting a plurality of bags 32 in a folded state, and is, for example, a pair of rails. The bag 32 is set on the guide portion 31, for example, by hooking a handle 321 that supports the bag 32 on the guide portion 31.

The guide portion 31 is inclined in the same direction at substantially the same angle as the inclined surface 142, one end portion 34 is located on the front side of the self-service POS terminal 10, and the other end side 37 is located on the back side of the self-service POS terminal 10. That is, the guide portion 31 is attached with a downward inclination having substantially the same angle as the inclined surface 142 from the one end portion 34 toward the other end side 37. The bag 32 is set on the guide portion 31 from one end portion 34 and guided toward the other end side 37 (in the direction of arrow T). The guide of the bag 32 may be performed by the own weight of the bag 32, or may be performed by a pushing mechanism for pushing the bag 32 in the direction of the arrow T (not shown).

Further, the bag opening mechanism 35 is a device that unfolds the bag 32 guided to a predetermined position from the folded state to the open state. The predetermined position is a position where the commodity P in the basket 20 slides and drops if the door 148 is opened. That is, the bag opening mechanism 35 opens the folded bag 32 located at a position where the commodity P in the basket 20 slides and drops. The opening of the bag 32 by the bag opening mechanism 35 is performed, for example, by the bag opening mechanism 35 grasping and expanding the handle 321.

The bag 32 is changed from the folded state to the open state. In FIG. 4, the folded bag is the bag 32 and the opened bag is the bag 33. By opening, the falling commodity P can easily drop into the bag 33. The slid commodities are packed in a bag by falling into the bag 33. The bag 33 packed with the commodity P is guided to a commodity outlet 36 for taking out the bag 33, which is provided on the back side of the self-service POS terminal 10.

In the state of FIG. 4, the door 148 is in a closed state. If the basket 20 is placed on the commodity placing unit 14, the basket 20 comes into contact with the door 148 at the lowermost portion 149 on the inclined surface 142. In this state, the protrusion 24 engages with the recess 151. FIG. 4 shows a state in which the protrusion 24 and the recess 151 are engaged with each other. On the other hand, the bag 32 located at the drop position of the commodity P is opened by the bag opening mechanism 35 and becomes the state of the bag 33.

If the bag need, which will be described later, is instructed, the motor 167 rotates and the door 148 moves upward. At this time, since the protrusion 24 and the recess 151 are engaged with each other, the opening and closing portion 23 moves upward in conjunction with the upward movement of the door 148. That is, the door 148 and the opening and closing portion 23 are opened, and the opening 26 is formed in the basket 20. FIG. 5 shows a state in which the door 148 and the opening and closing portion 23 are in the open state. In the state of FIG. 5, since the basket 20 is inclined by the inclined surface 142, the commodity P stored in the basket 20 slides outward from the opening 26 and drops into the opened bag 33. In this way, the commodity P stored in the basket 20 is automatically packed in the bag 33. The bag 33 in which the commodity P is packed is guided to the commodity outlet 36 by the guide portion 31. The customer moves to the back side of the self-service POS terminal 10 and receives the bag 33 located at the commodity outlet 36.

Although the details will be described later, the customer who does not need to bag the commodity P can prevent the self-service POS terminal 10 from bagging the commodity P by the operation.

Next, the hardware configuration of the self-service POS terminal 10 will be described. FIG. 6 is a block diagram showing a hardware configuration of the self-service POS terminal 10. As shown in FIG. 6, the self-service POS terminal 10 includes a CPU (Central Processing Unit) 51, a ROM (Read Only Memory) 52, a RAM (Random Access Memory) 53, a memory unit 54, and the like. The CPU 51 is the main control body. The ROM 52 stores various programs. The RAM 53 loads programs and various data. The memory unit 54 stores various programs. The CPU 51, the ROM 52, the RAM 53, and the memory unit 54 are connected to each other via a bus 55. The CPU 51, the ROM 52, and the RAM 53 constitute the control unit 500. That is, the control unit 500 executes the control process of the self-service POS terminal 10, which will be described later, by operating the CPU 51 according to the control program stored in the ROM 52 or the memory unit 54 and loaded in the RAM 53.

The RAM 53 includes a commodity information unit 531. The commodity information unit 531 stores the commodity information (commodity code, commodity name, commodity price, and the like) of the commodity P that was subjected to the commodity registration process.

The memory unit 54 is composed of a non-volatile memory such as an HDD (Hard Disc Drive) or a flash memory that retains stored information even if the power is turned off, and stores a control program unit 541 that stores a control program, which controls the self-service POS terminal 10, and a commodity master 542. The commodity master 542 stores the commodity information of the commodity P in association with the commodity code for identifying the commodity P.

Further, the control unit 500 is connected to the operation unit 165, the display unit 161, the settlement terminal 164, the printer 166, the code reading unit 163, and the motor 167 via the bus 55 and a controller 56. The controller 56 receives an instruction from the control unit 500 and controls the operation unit 165, the display unit 161, the settlement terminal 164, the printer 166, and the card reader 168. However, for convenience of description, the control performed by the controller 56 will be described to be performed by the control unit 500.

The operation unit 165 is a touch panel provided with a keyboard such as a start key 1651, an end key 1652, a bag need key 1653, and a bag no-need key 1654, and is operated by a customer who is an operator of the self-service POS terminal 10. The start key 1651 is operated when starting to use the self-service POS terminal 10. The end key 1652 is operated when making a settlement on the self-service POS terminal 10. The bag need key 1653 is operated if the bag 32 is necessary and the commodity P is automatically packed in the bag 32. The bag no-need key 1654 is operated if the bag 32 is unnecessary and the commodity P is not packed in the bag 32. For example, if a customer brings his or her own bag or the like, the customer operates the bag no-need key 1654. If the bag no-need key 1654 is operated, the self-service POS terminal 10 does not perform the bagging process of the commodity P. The motor 167 is a motor that rotates to move the door 148 upward and downward.

Further, the control unit 500 is connected to a communication unit 57 via the bus 55. The communication unit 57 is connected to a server installed in a store or another self-service POS terminal 10 (none of which is shown) via a communication line (not shown). The communication unit 57 transmits and receives information to and from the server and other self-service POS terminals 10 via a communication line L.

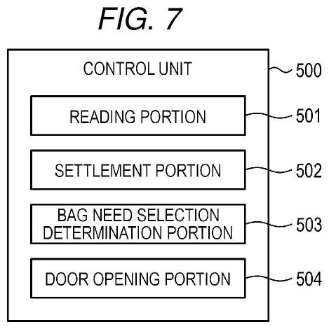

Next, the functional configuration of the self-service POS terminal 10 will be described. FIG. 7 is a functional block diagram showing a functional configuration of the self-service POS terminal 10. As shown in FIG. 7, the control unit 500 of the self-service POS terminal 10 follows the control program stored in the control program unit 541 of the ROM 52 and the memory unit 54 to function as a reading portion 501, a settlement portion 502, a bag need selection determination portion 503, and a door opening portion 504.

The reading portion 501 reads the information for identifying the commodity P transmitted from the wireless tag attached to the commodity P stored in the basket 20 placed on the commodity placing unit 14. Specifically, the reading portion 501 reads the information for identifying the commodity P stored in the basket 20 placed on the commodity placing unit 14 based on the information for identifying the commodity P received by any or all of the antenna 143, the antenna 145, and the antenna 147.

The settlement portion 502 executes the settlement process based on the information of the commodity P read by the reading portion 501. Specifically, the settlement portion 502 executes the settlement process for the commodity P that was subjected to the commodity registration process based on the information of the commodity P read by the reading portion 501.

The bag need selection determination portion 503 determines whether the need-for-a-bag is selected or the no-need-for-a-bag is selected by the customer. Specifically, the bag need selection determination portion 503 determines which of the bag need key 1653 and the bag no-need key 1654 displayed on the display unit 161 was operated.

The door opening portion 504 opens the door 148. Specifically, the door opening portion 504 rotates the motor 167 to open the door 148. More specifically, the door opening portion 504 rotates the motor 167 to open the door 148 if the bag need selection determination portion 503 determines that the need-for-a-bag was selected. The door opening portion 504 does not open the door 148 if the bag need selection determination portion 503 determines that the no-need-for-a-bag was selected. More specifically, the door opening portion 504 rotates the motor 167 to open the door 148 if the bag need selection determination portion 503 determines that the bag need key 1653 was operated. The door opening portion 504 does not open the door 148 if the bag need selection determination portion 503 determines that the bag no-need key 1654 was operated. Further, the door opening portion 504 opens the door 148 under the condition that the settlement process was executed.

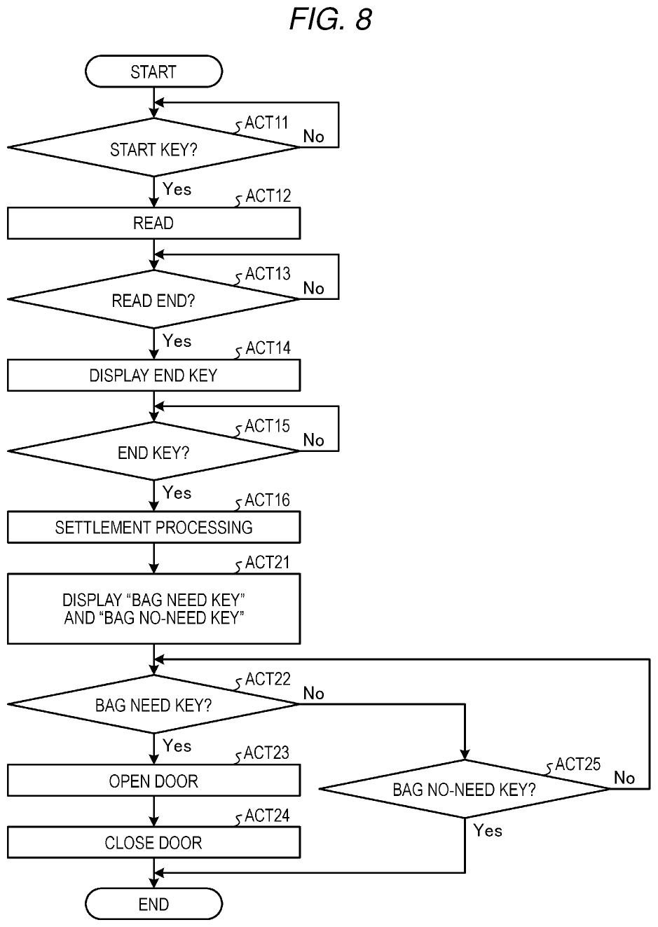

Next, the control of the self-service POS terminal 10 will be described. FIG. 8 is a flowchart showing the control process of the self-service POS terminal 10. As shown in FIG. 8, the control unit 500 of the self-service POS terminal 10 determines whether the start key 1651 corresponding to the image of the start key displayed on the display unit 161 was operated (ACT 11). After waiting until the start key 1651 is operated (No in ACT 11), if it is determined that the start key 1651 was operated (Yes in ACT 11), the reading portion 501 activates the antenna 143, the antenna 145, and the antenna 147, and reads the information for identifying the commodity P transmitted from the wireless tag attached to the commodity P stored in the basket 20 placed on the commodity placing unit 14 (ACT 12). Specifically, the reading portion 501 reads the information for identifying the commodity P based on the information received by the antenna 143, the antenna 145, and the antenna 147. Based on the information of the commodity P read by the reading portion 501, the control unit 500 executes the commodity registration process for the commodity P, and stores the commodity information of the commodity P that was subjected to the commodity registration process in the commodity information unit 531.

Next, the control unit 500 determines whether the reading of the information for identifying the commodity P by the reading portion 501 was completed (ACT 13). The control unit 500 determines the reading end, for example, if the reading portion 501 continuously reads the information for identifying the commodity P for a predetermined time. After waiting until the end of reading is determined (No in ACT 13), if the end of reading is determined (Yes in ACT 13), the control unit 500 displays the image of the end key on the display unit 161 (ACT 14). The customer checks the commodity information displayed on the display unit 161 and operates the end key 1652 corresponding to the image of the end key if the commodity information of all the commodities is displayed.

Next, the control unit 500 determines whether the end key 1652 was operated (ACT 15). After waiting until the end key 1652 is operated (No in ACT 15), if it is determined that the end key 1652 was operated (Yes in ACT 15), the settlement portion 502 executes the settlement process related to the commodity P based on the commodity information subjected to the commodity registration process and stored in the commodity information unit 531 (ACT 16).

Next, the control unit 500 displays an image of the bag need key and an image of the bag no-need key on the display unit 161 (S21). If the customer desires to automatically pack the purchased commodity P in the bag 32 provided in the self-service POS terminal 10, the customer operates the bag need key 1653 corresponding to the image of the bag need key. On the other hand, if the customer does not need to pack the purchased commodity P in the bag 32 provided in the self-service POS terminal 10 (that is, the bag 32 itself is unnecessary), the customer operates the bag no-need key 1654 corresponding to the image of the bag no-need key.

Next, the bag need selection determination portion 503 determines whether the bag need key 1653 was operated (ACT 22). If it is determined that the bag need key 1653 was operated (Yes in ACT 22), the door opening portion 504 rotates the motor 167 and moves the door 148 upward to open the door (ACT 23). At this time, the opening and closing portion 23 also moves upward in conjunction with the door. In this state, the commodity P stored in the basket 20 slides from the opening 26 and drops into the opened bag 33. That is, the commodity P is automatically packed in the bag 33.

Next, the control unit 500 rotates the motor 167 and moves the door 148 downward to close the door (ACT 24). At this time, the opening and closing portion 23 also moves downward. The process of ACT 24 by the control unit 500 may be performed, for example, after a predetermined time elapsed from the process of ACT 23, or the process of ACT 24 may be performed if it is determined by a sensor (not shown) that no commodity P remains in the basket 20. Then, the control unit 500 ends the process and returns to ACT 11.

On the other hand, if it is determined in ACT 22 that the operation of the bag need key 1653 is not performed (No in ACT 22), the bag need selection determination portion 503 determines whether the bag no-need key 1654 was operated (ACT 25). If it is determined that the bag no-need key 1654 was operated (Yes in ACT 25), the control unit 500 ends the process and returns to ACT 11. That is, the control unit 500 does not process the bagging of the commodities stored in the basket 20. If it is determined that the operation of the bag no-need key 1654 is not performed (No in ACT 25), the control unit 500 returns to ACT 22.

The self-service POS terminal 10 of such an embodiment includes the commodity placing unit 14 having the inclined surface 142 and on which the commodity P is placed, the openable and closable door 148 provided at the lowermost portion 149 of the inclined surface 142, determining the position of the basket 20 placed on the commodity placing unit 14 in the closed state, and allowing the commodity P stored in the placed basket 20 to slide outward along the inclined surface 142 in the open state, and the storage mechanism 30 for dropping the slid commodity P into the bag 33 set at the sliding movement destination of the commodity P.

The self-service POS terminal 10 of such an embodiment automatically packs the commodity P stored in the basket 20 into the bag 33. Therefore, it is possible for the customer to reduce the efforts of packing the commodity P in a bag.

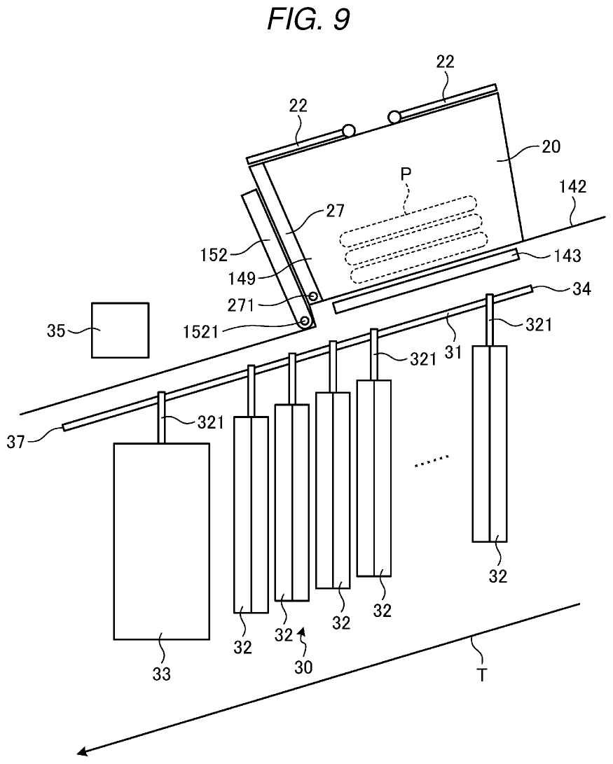

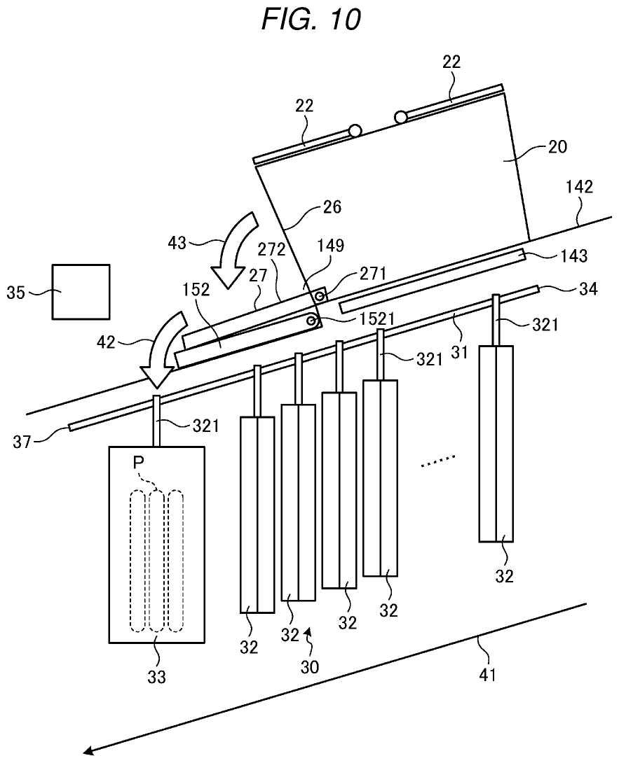

From here, a modification of the embodiment will be described. FIGS. 9 and 10 are explanatory diagrams showing the inside of the modification of the embodiment. FIG. 9 is a diagram corresponding to FIG. 4, and FIG. 10 is a diagram corresponding to FIG. 5. Further, in the modification, the same reference numerals are given to the same configurations as those of the embodiment, and the description thereof will be simplified or omitted.

In FIG. 9, the basket 20 is in contact with the door 152. In this state, the door 152 and the opening and closing portion 27 are provided with a metal portion. For example, the metal portion is attracted by the attractive force of a magnet provided in the door 152, and the door 152 and the opening and closing portion 27 are attached to each other.

Further, in the embodiment, the door 148 is moved upward by the rotation of the motor 167, but in the modification, the door 152 is rotated around a rotation fulcrum 1521 by the rotation of the motor 167. Specifically, as a movement corresponding to the upward movement of the door 148, the door 152 rotates in the downward inclined direction of the inclined surface 142 (direction of arrow 43 in FIG. 10) to an angle substantially parallel to the inclined surface 142 about the rotation fulcrum 1521 and becomes an open state (a state in FIG. 10). Further, the door 152 rotates to an angle close to a right angle to the inclined surface 142 (direction opposite to the arrow 43) and becomes a closed state (a state in FIG. 9). Further, the opening and closing portion 27 rotates about a fulcrum 271. The opening and closing portion 27 functions as the storage unit 21 of the basket 20 in the closed state. The opening and closing portion 27 rotates about the fulcrum 271 in the downward inclined direction of the inclined surface 142 (direction of arrow 43 in FIG. 10) to an angle substantially parallel to the inclined surface 142 and becomes an open state (the state in FIG. 10). If the opening and closing portion 27 is in the open state, the commodities stored in the basket 20 can slide along the inclined surface 142.

FIG. 9 shows a state in which the door 152 is rotated to the right around the rotation fulcrum 1521 and is in the closed state. In this state, the basket 20 is positioned in contact with the door 152. The opening and closing portion 27 is attracted by a magnet provided on the door 152 and is attached to the door 152, but the opening and closing portion 27 is in a closed state and plays a role as a part of the storage unit 21.

FIG. 10 shows a state in which the door 152 is rotated to the left around the rotation fulcrum 1521 and is in the open state. If the door 152 rotates outward, the opening and closing portion 27 attracted by the magnet rotates in the direction away from the basket 20 in conjunction with the door 152 and becomes an open state. In this state, the opening 26 is formed in the basket 20. Then, the commodities P stored in the basket 20 slide on an upper surface 272 of the opening and closing portion 27 released from the opening 26, drops into the opened bag 33, and is packed in the bag 33.

The upper surface 272 of the opening and closing portion 27 is processed to reduce friction with the sliding commodity P. The upper surface 272 of the opening and closing portion 27 is, for example, coated to reduce friction. Further, for example, the upper surface 272 itself is formed of a low friction material. Further, for example, low friction may be realized by forming a roller rotating in the sliding direction of the commodity P on the upper surface 272 of the opening and closing portion 27.

As described above, the self-service POS terminal 10 of the modification includes the commodity placing unit 14 having the inclined surface 142 and on which the commodity P is placed, the openable and closable door 152 provided at the lowermost portion 149 of the inclined surface 142, determining the position of the basket 20 placed on the commodity placing unit 14 in the closed state, and allowing the commodity P stored in the placed basket 20 to slide outward along the inclined surface 142 in the open state, and the storage mechanism 30 for dropping the sliding commodity P into the bag 33 set at the sliding movement destination of the commodity P.

The self-service POS terminal 10 of such a modification automatically packs the commodity P stored in the basket 20 into the bag 33. Therefore, it is possible for the customer to reduce the efforts of packing the commodity P in a bag.

The control process of the self-service POS terminal 10 according to the embodiment shown in the flowchart of FIG. 8 is also applied to the modification. That is, in ACT 23, the door opening portion 504 rotates the door 152 to open the door 152. Further, in ACT 24, the control unit 500 rotates the door 152 in the direction opposite to that of ACT 23 to close the door 152.

While certain embodiments and modifications have been described, these embodiments and modifications have been presented by way of example only, and are not intended to limit the scope of the inventions. Indeed, the novel embodiments and modifications described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the embodiment and the modification, the basket 20 is placed on the commodity placing unit 14. However, the present disclosure is not limited thereto and the commodity P may be directly placed on the commodity placing unit 14. That is, the basket 20 is not essential. If the commodity P is directly placed on the commodity placing unit 14 and the door 148 or the door 152 is in the open state, the commodity P placed on the commodity placing unit 14 passes through the opening 26, slides, drops into the bag 33, and is packed in a bag.

Further, in the embodiment and the modification, the bagging process is automatically executed if the bag need key 1653 is operated, and the bagging process is not executed if the bag no-need key 1654 is operated. However, the present disclosure is not limited thereto, and for example, the bagging process may be executed whenever the settlement process is executed.

Further, in the embodiment and the modification, the three antennas including the antenna 143, the antenna 145, and the antenna 147 were described. However, the present disclosure is not limited thereto and the number of antennas and the mounting position may be appropriately determined.

Further, in the embodiment and the modification, the self-service POS terminal 10 was described as an example of the bagging device. However, the bagging device is not limited thereto, and it is not essential for the bagging device to have a mechanism and a function for reading a wireless tag such as an antenna, and a function for performing the commodity registration process and the settlement process.

Further, in the embodiment and the modification, the image of the bag need key and the image of the bag no-need key are displayed in ACT 21 after the settlement process of ACT 16 is completed. In addition, the determination of ACT 22 and ACT 25 was subsequently made. However, the present disclosure is not limited thereto, and for example, the settlement process of ACT 16 may be executed after the determination of ACT 22 and the determination of ACT 25. In this case, if it is determined in ACT 22 that the bag is necessary, the settlement process including the price of the bag (charged) can be performed thereafter. Further, if it is determined in ACT 25 that the bag is unnecessary, a settlement process that does not include the price of the bag can be performed thereafter.

Further, in the embodiment and the modification, the inclined surface 142 is provided to be inclined downward from the front side to the back side. However, the present disclosure is not limited thereto, and for example, an inclined surface that is inclined downward in the left-right direction may be used, and any inclined direction of the inclined surface 142 may be determined.

The program executed by the self-service POS terminal 10 of the embodiment and the modification is recorded and provided as a file in an installable format or an executable format on a computer-readable recording medium such as a CD-ROM, a flexible disk (FD), a CD-R, or a DVD (Digital Versatile Disk).

Further, the program executed by the self-service POS terminal 10 of the embodiment and the modification may be configured to be stored in a computer connected to a network such as the Internet and provided by being downloaded via the network. Further, the program executed by the self-service POS terminal 10 of the embodiment and the modification may be configured to be provided or distributed via a network such as the Internet.

Further, the programs executed by the self-service POS terminal 10 of the embodiment and the modification may be configured to be provided by incorporating programs into a ROM or the like in advance.

What is claimed is:

1. A bagging device, comprising:
a commodity placing component having an inclined surface and on which a commodity is placed;
an openable and closable door provided at a lowermost portion of the inclined surface, the openable and closable door configured to determine a position of the commodity placed on the commodity placing component in a closed state and allow the placed commodity to move outward along the inclined surface in an open state; and
a storage mechanism for dropping the commodity into a storage body set at the movement destination of the commodity.

2. The bagging device according to claim 1, wherein
on the commodity placing component, a basket having an opening and closing portion is placed to be inclined on the inclined surface, and
the openable and closable door determines the position of the basket placed on the commodity placing component in the closed state, opens the opening and closing portion, and allows the commodity stored in the placed basket to move from the basket to an outside of the commodity placing component along the inclined surface in the open state.

3. The bagging device according to claim 1, wherein
the openable and closable door is opened by upward movement, and closed by downward movement.

4. The bagging device according to claim 1, wherein
the openable and closable door is opened by rotating in a downward inclined direction of the inclined surface and closed by rotating in a direction opposite to the rotating direction.

5. The bagging device according to claim 4, wherein
the openable and closable door is provided to reduce friction with the commodity on the upper surface on which the commodity moves in a state of being rotated in the downward inclined direction of the inclined surface.

6. The bagging device according to claim 1, further comprising:
a controller for opening the openable and closable door upon or after execution of a settlement process for the commodity placed on the commodity placing component.

7. The bagging device according to claim 1, wherein
the storage mechanism comprises a plurality of storage bodies.

8. A bagging method for a point-of-sale system, comprising:
determining a position of a commodity placed on a commodity placing component having an inclined surface in a closed state and allow the placed commodity to move outward along the inclined surface in an open state through an openable and closable door provided at a lowermost portion of the inclined surface; and
dropping the commodity into a storage body in a storage mechanism set at the movement destination of the commodity.

9. The bagging method according to claim 8, further comprising:
placing a basket having an opening and closing portion to be inclined on the inclined surface;
the openable and closable door determining the position of the basket placed on the commodity placing component in the closed state;
opening the opening and closing portion; and
allowing the commodity stored in the placed basket to move from the basket to an outside of the commodity placing component along the inclined surface in the open state.

10. The bagging method according to claim 8, further comprising:
opening the openable and closable door using an upward movement, and closing the openable and closable door using by a downward movement.

11. The bagging method according to claim 8, further comprising:
opening the openable and closable door by rotating in a downward inclined direction of the inclined surface and closing the openable and closable door by rotating in a direction opposite to the rotating direction.

12. The bagging method according to claim 11, wherein
the openable and closable door is provided to reduce friction with the commodity on the upper surface on which the commodity moves in a state of being rotated in the downward inclined direction of the inclined surface.

13. The bagging method according to claim 8, further comprising:
opening the openable and closable door upon or after execution of a settlement process for the commodity placed on the commodity placing component.

14. A self service point-of-sale system, comprising:
a commodity registration component;
a commodity settlement component; and
a bagging device, comprising:
a commodity placing component having an inclined surface and on which a commodity is placed;
an openable and closable door provided at a lowermost portion of the inclined surface, the openable and closable door configured to determine a position of the commodity placed on the commodity placing component in a closed state and allow the placed commodity to move outward along the inclined surface in an open state; and
a storage mechanism for dropping the commodity into a storage body set at the movement destination of the commodity.

15. The self service point-of-sale system according to claim 14, wherein
on the commodity placing component, a basket having an opening and closing portion is placed to be inclined on the inclined surface, and
the openable and closable door determines the position of the basket placed on the commodity placing component in the closed state, opens the opening and closing portion, and allows the commodity stored in the placed basket to move from the basket to an outside of the commodity placing component along the inclined surface in the open state.

16. The self service point-of-sale system according to claim 14, wherein
the openable and closable door is opened by upward movement, and closed by downward movement.

17. The self service point-of-sale system according to claim 14, wherein
the openable and closable door is opened by rotating in a downward inclined direction of the inclined surface and closed by rotating in a direction opposite to the rotating direction.

18. The self service point-of-sale system according to claim 17, wherein
the openable and closable door is provided to reduce friction with the commodity on the upper surface on which the commodity moves in a state of being rotated in the downward inclined direction of the inclined surface.

19. The self service point-of-sale system according to claim 14, further comprising:
a controller for opening the openable and closable door upon or after execution of a settlement process for the commodity placed on the commodity placing component.

20. The self service point-of-sale system according to claim 14, wherein
the storage mechanism comprises a plurality of storage bodies.
